(19) United States
(12) Patent Application Publication
(10) Pub. No.: US 2014/0258444 A1
(43) Pub. Date: Sep. 11, 2014

(54) NETWORK CLOUD COMMUNICATION FOR IP CAMERA

(71) Applicant: ZYXEL COMMUNICATIONS, INC., Anaheim, CA (US)

(72) Inventors: Steven Joe, Coto de Caza, CA (US); Shawn Rogers, Anaheim, CA (US)

(73) Assignee: Zyxel Communications, Inc., Anaheim, CA (US)

(21) Appl. No.: 13/786,271

(22) Filed: Mar. 5, 2013

(51) Int. Cl. H04L 29/08

(52) U.S. Cl. CPC H04L 67/12
USPC 709/217; 709/227

(57) ABSTRACT

Subject matter disclosed herein relates to a method that may be performed at a cloud server, the method comprising: establishing a first network connection to an Internet-Protocol (IP) camera in response to a request from the IP camera; establishing a second network connection to a mobile device in response to a second request from the mobile device; and facilitating a third network connection between the IP camera and the mobile device.

### BACKGROUND

1. Field

Subject matter disclosed herein relates to sharing video or photos captured by an Internet Protocol camera over the Internet, and in particular, managing the sharing, at least in part, using a cloud server.

2. Information

An Internet protocol (IP) camera may comprise a digital camera for capturing photos and/or video. IP cameras may send and receive data via a computer network or the Internet. IP cameras may be employed for any of a number of applications, such as surveillance, telecommunication, and social networking, just to name a few examples. IP cameras, in some cases, may be referred to as webcams.

Cloud computing may involve computing resources (i.e., hardware and/or software) that are provided over a network such as the Internet. Such computing resources may include, for example, a cloud server comprising a processor to execute any of a number of cloud computing applications.

A social networking service may comprise an Internet service, platform, or site directed to allowing users to interact or to share ideas, activities, events, or interests, for example.

### BRIEF DESCRIPTION OF THE FIGURES

Non-limiting and non-exhaustive features will be described with reference to the following figures, wherein like reference numerals refer to like parts throughout the various figures.

FIG. 1 is a system diagram illustrating certain features of a system containing a mobile device and an IP camera, according to an embodiment.

FIG. 2 is a system diagram illustrating certain features of a system containing a mobile device and an IP camera, according to another embodiment.

FIGS. 3 and 4 are flow diagrams of embodiments of a process to share photos or video over the Internet.

FIG. 5 is a schematic block diagram illustrating an exemplary mobile device, according to an embodiment.

FIG. 6 is a schematic block diagram of an example computing platform, according to an embodiment.

### DETAILED DESCRIPTION

Reference throughout this specification to “one embodiment” or “an embodiment” means that a particular feature, structure, or characteristic described in connection with an embodiment is included in at least one embodiment of claimed subject matter. Thus, appearances of phrases such as “in one embodiment” or “an embodiment” in various places throughout this specification are not necessarily all referring to the same embodiment. Furthermore, particular features, structures, or characteristics may be combined in one or more embodiments.

In an embodiment, a mobile device may display video or photos captured remotely by an Internet-Protocol (IP) camera. The mobile device may include a processor to execute one or more applications to record such video or photos or to upload the video or photos to a computing device (e.g., another mobile device, server, or computer terminal) at another location remote from the mobile device. In one implementation, communication among such an IP camera, a mobile device, and a remote computing device may be performed via the Internet or other network, though claimed subject matter is not so limited. In another implementation, such communication may be at least partially managed by a social networking site on the Internet.

A mobile device may comprise a device such as a cellular or other wireless communication device, personal communication system (PCS) device, personal navigation device, Personal Information Manager (PIM), Personal Digital Assistant (PDA), laptop or other suitable mobile station which is capable of receiving wireless communications. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

In one embodiment, at least a portion of a system for sharing video or photos may comprise an IP camera, a cloud server, a mobile device, and/or a social networking site. A method performed at a cloud server may comprise establishing a first network connection to an IP camera in response to a request from the IP camera, and establishing a second network connection to a mobile device in response to a second request from the mobile device. For example, a cloud server may receive a request from an IP camera to establish a network connection between the cloud server and the IP camera. The cloud server may also receive a request from a mobile device to establish another network connection between the cloud server and the mobile device. Upon or after establishing first and second network connections to an IP camera and a mobile device, respectively, the cloud server may facilitate a third network connection between the IP camera and the mobile device. In one implementation, the third network connection may include the cloud server. For example, communication between the IP camera and the mobile device along the third network connection may transmit through the cloud server. On the other hand, in another implementation, the third network connection need not include the cloud server. Instead, the third network connection may comprise a peer to peer connection between the IP camera and the mobile device. In this case, communication between the IP camera and the mobile device along the third network connection may bypass the cloud server.

In a particular implementation, the cloud server may relay photos or video between the IP camera and the mobile device using the third network connection. In another particular implementation, the cloud server may relay commands from the mobile device to the IP camera using the third network connection. For example, such commands may comprise instructions for the IP camera to capture a particular image or to record a particular video.

In another embodiment, a method performed at a mobile device may involve a user of the mobile device selecting a particular IP camera among one or more IP cameras. For example, a mobile device may display a list of available IP cameras from which to select. Upon or after such a selection, the mobile device may transmit a request over a first network connection to a cloud server to establish a second network connection to the selected IP camera. For example, a first network connection may comprise a connection between the mobile device and the cloud server, while a second network connection may comprise a connection between the selected IP camera and the cloud server. The mobile device may subsequently receive over the first network connection identification of the selected IP camera. Such identification may be useful for the mobile device to confirm that the second network connection was made to the correct IP camera. A third network connection may then be used by the mobile device to receive a photo or video stream from the selected IP camera.

In one implementation, the third network connection may include the cloud server. On the other hand, in another implementation, the third network connection need not include the cloud server. Instead, the third network connection may comprise a peer to peer connection between the selected IP camera and the mobile device.

In another implementation, the second network connection may comprise a peer to peer connection between the particular IP camera and the cloud server.

In one embodiment, a mobile device may transmit commands to an IP camera using a third network connection. Such commands, for example, may comprise instructions for an IP camera to capture an image or to record a video. In some cases, a mobile device may store an image or video received from an IP camera in memory in the mobile device. A mobile device may also transmit an image or video (whether stored in memory or not) to a social media Internet site via a first network connection.

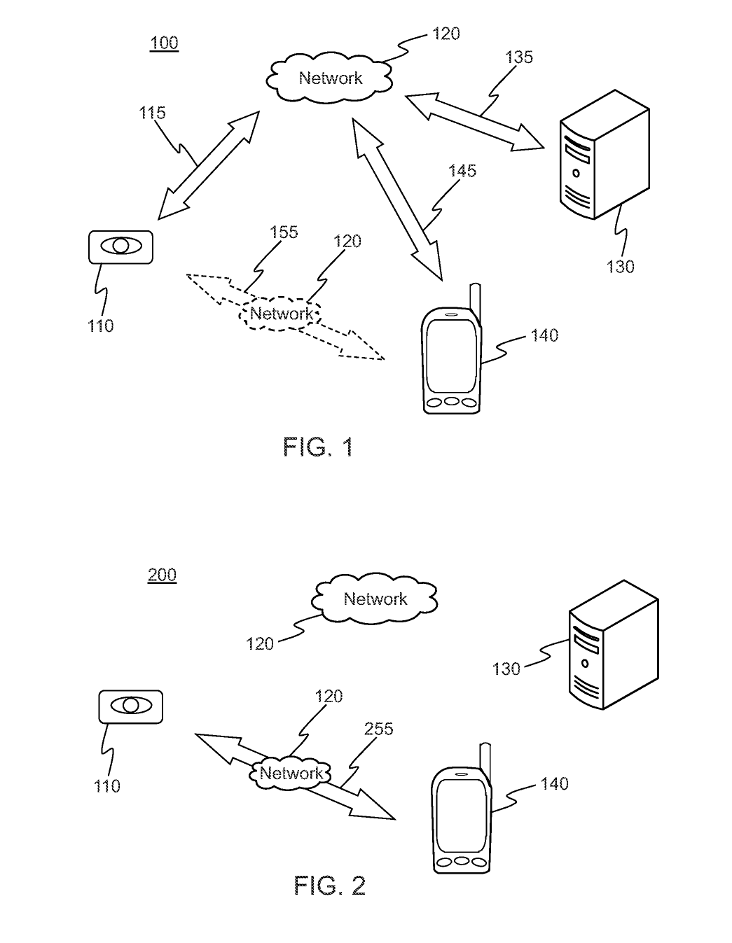

FIG. 1 is a system diagram illustrating certain features of a system 100 containing a mobile device 140 and an IP camera 110, according to an embodiment. System 100 may further include a cloud server 130 and a communication network 120. Cloud server 130 may comprise a computer platform located at any part of network 120, which may comprise the Internet, WiFi, or other network, for example. Mobile device 140 may wirelessly transmit radio signals to, and receive radio signals from, any of a number of elements (e.g., computer platforms, terminals, and so on) included in communication network 120 over a communication link 145, which may be wireless. Of course, it should be understood that this is merely an example of a network that may facilitate communicate with a mobile device, and claimed subject matter is not limited in this respect.

In a particular implementation, IP camera 110 and mobile device 140 may communicate with cloud server 130 over a network 120 through communication links 115, 135, and 145. Here, network 120 may comprise any combination of wired or wireless links. In a particular implementation, network 120 may comprise Internet Protocol (IP) infrastructure capable of facilitating communication between mobile device 140 and cloud server 130 through communication links 135, and 145. Similarly, network 120 may comprise Internet Protocol (IP) infrastructure capable of facilitating communication between IP camera 110 and cloud server 130 through communication links 115 and 135.

In an implementation, network 120 may comprise a cellular communication network infrastructure such as, for example, a base station controller or master switching center (not shown) to facilitate mobile cellular communication with mobile device 140.

In particular implementations, and as discussed below, mobile device 140 may have circuitry and processing resources capable of generating commands or requests to cloud server 130 or IP camera 110 via network 120, for example. In other particular implementations, and as discussed below, mobile device 140 may have circuitry and processing resources capable of generating commands or requests to IP camera 110 via network 120 using a communication link 155 that need not include cloud server 130, for example.

FIG. 2 is a system diagram illustrating certain features of system 200 containing mobile device 140 and IP camera 110, according to another embodiment. As mentioned above, mobile device 140 may have circuitry and processing resources capable of communicating to IP camera 110 via network 120 using a communication link 255 that need not include cloud server 130, for example. As discussed below, cloud server 130 may facilitate communication link 255 upon or after establishing communication links 115 and 145, shown in FIG. 1. Accordingly, in one implementation, communication link 255 may comprise a peer-to-peer network connection between IP camera 110 and mobile device 140. In another implementation, communication link 255 may comprise a network connection between IP camera 110 and mobile device 140 that is relayed through cloud server 130 (e.g., such as involving communication link 135 shown in FIG. 1).

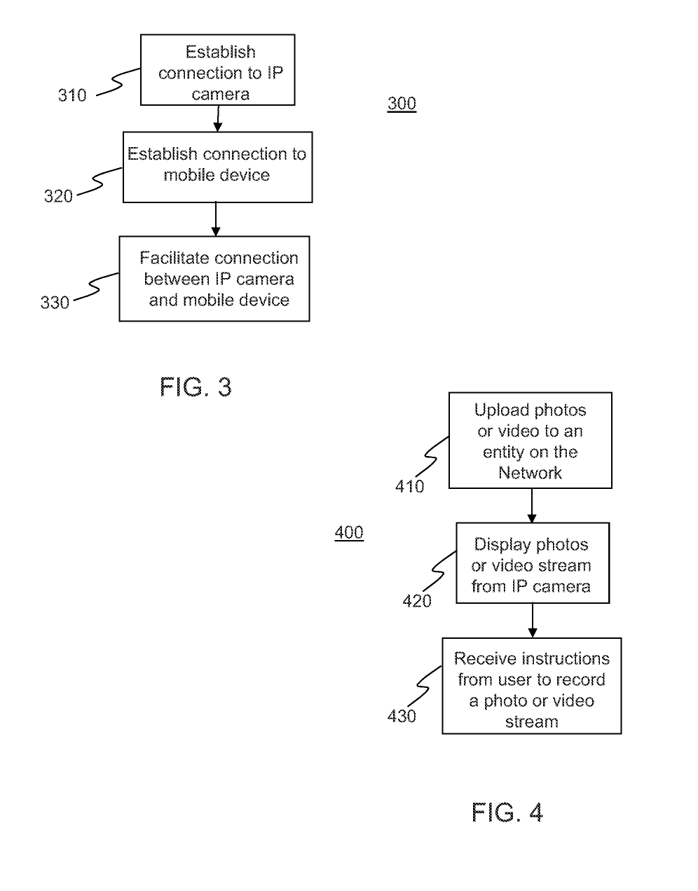

FIG. 3 is a flow diagram of an embodiment of a process 300 to share photos or video over the Internet. Process 300 may be performed at a cloud server, such as 130 in FIGS. 1 and 2, for example. At block 310, a cloud server may comprise establishing a network connection to an IP camera. For example, a network connection may be established in response to a request from the IP camera. In another example, however, a cloud server may initiate a network connection to an IP camera. At block 320, the cloud server may establish a second network connection to a mobile device. For example, a cloud server may receive a request from an IP camera to establish a network connection between the cloud server and the IP camera. The cloud server may also receive a request from a mobile device to establish a network connection between the cloud server and the mobile device. Process 300 may proceed to block 330 upon or after establishing first and second network connections to the IP camera and the mobile device, respectively. At block 330, the cloud server may facilitate a third network connection between the IP camera and the mobile device. Such a third network connection may include the cloud server. On the other hand, the third network connection need not include the cloud server. Instead, the third network connection may comprise a peer to peer connection between the IP camera and the mobile device. In one implementation, the cloud server may gather an IP address and/or port used by the IP camera, and then provide such gathered information to the mobile device, while also providing the IP camera with an IP address of the mobile device. In this way, the mobile device and the IP camera may establish a direct connection with one another. In one particular implementation, instructions generated by the mobile device for the IP camera to capture a particular image or to record a particular video may be sent over the third network connection.

In a particular implementation, a peer to peer connection between an IP camera and a mobile device, which is not relayed via a cloud server, may be present while the cloud server relays photos or video among the mobile device and any part of the Internet, such as a social network, for example. Of course, these details of process 300 are merely examples, and claimed subject matter is not so limited.

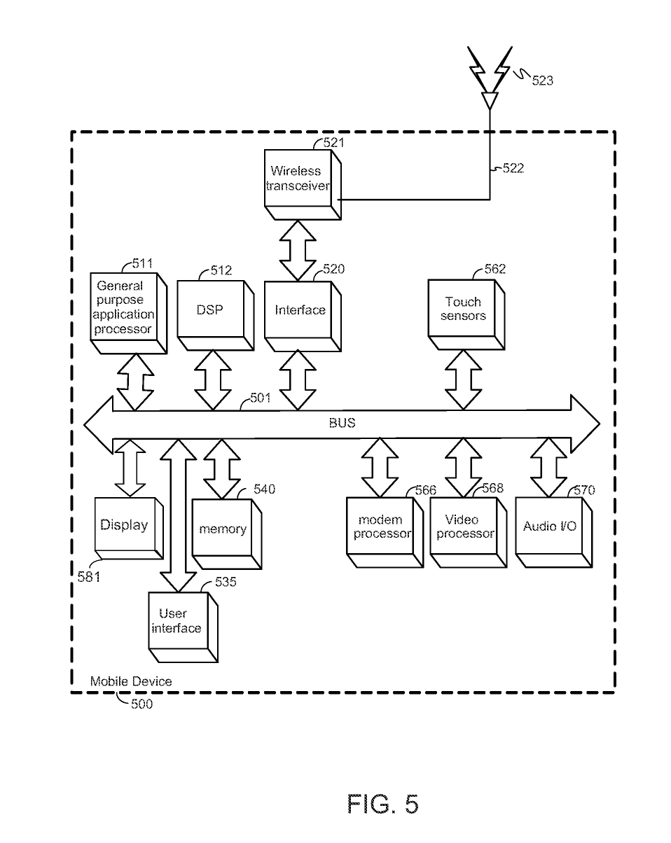

FIG. 4 is a flow diagram of an embodiment of a process 400 to share photos or video over the Internet. Process 400 may be performed at a mobile device, for example. At block 410, a mobile device may upload photos or video to an entity, such as a social network, for example, on the Internet. At block 420, photos or a video stream captured by the IP camera may be displayed by the mobile device. For example, an application hosted by the mobile device may be executed to display one or more photos or videos selected by a user of the mobile device. At block 430, photos or a video stream captured by the IP camera may be recorded and saved in memory on board the mobile device. For example, an application hosted by the mobile device may be executed to record or store one or more photos or videos selected by a user of the mobile device. Of course, such details of process 400 are merely examples, and claimed subject matter is not so limited.

FIG. 5 is a schematic block diagram of a mobile device 500, according to an implementation. Mobile device 500 may comprise one or more features of mobile device 140 shown in FIG. 1, for example. In certain implementations, mobile device 500 may also comprise a wireless transceiver 521 which is capable of transmitting and receiving wireless signals 523 via an antenna 522 over a wireless communication network, such as over a wireless communication link 145 shown in FIG. 1, for example. Wireless transceiver 521 may be connected to bus 501 by a wireless transceiver bus interface 520. Wireless transceiver bus interface 520 may, in some implementations be at least partially integrated with wireless transceiver 521. Some implementations may include multiple wireless transceivers 521 and wireless antennas 522 to enable transmitting and/or receiving signals according to a corresponding multiple wireless communication standards such as, for example, WiFi, CDMA, WCDMA, LTE and Bluetooth, just to name a few examples.

Also shown in FIG. 5, mobile device 500 may comprise digital signal processor(s) (DSP(s)) 512 connected to the bus 501 by a bus interface 510, general-purpose processor(s) 511 connected to the bus 501 by a bus interface 510 and memory 540. Bus interface 510 may be integrated with the DSP(s) 512, general-purpose processor(s) 511 and memory 540.

In various implementations, functions or processes, such as processes 300 and/or 400 shown in FIGS. 3 and 4, for example, may be performed in response to execution of one or more machine-readable instructions stored in memory 540 such as on a computer-readable storage medium, such as RAM, ROM, FLASH, or disc drive, just to name a few example. The one or more instructions may be executable by general-purpose processor(s) 511, specialized processors, or DSP(s) 512. In one implementation, for example, one or more machine-readable instructions stored in a non-transitory storage medium, such as memory 540 for example, may be executable by a special purpose computing device (e.g., processor(s) 511) to: receive user instructions to select a particular IP camera among one or more IP cameras; generate a request configured for communication over a first network connection to a cloud server to establish a second network connection to the particular IP camera; receive identification of the particular IP camera via the first network connection; and receive a photo/video stream via a third network connection from the particular IP camera.

A third connection may include the cloud server, for example. On the other hand, the third connection may comprise a peer to peer connection between the particular IP camera and the mobile device. The second connection may comprise a peer to peer connection between the particular IP camera and the cloud server, for example. In one implementation, machine-readable instructions may be further executable by a special purpose computing device to generate commands for transmission to the IP camera using the third network connection, the commands comprising instructions to capture an image or to record a video. In another implementation, machine-readable instructions may be further executable by a special purpose computing device to generate a signal comprising the image or the video for transmission to a social media Internet site via the first network connection.

Memory 540 may comprise a non-transitory processor-readable memory and/or a computer-readable memory that stores software code (programming code, instructions, etc.) that are executable by processor(s) 511 and/or DSP(s) 512 to perform functions described herein.

Also shown in FIG. 5, a user interface 535 may comprise any one of several devices such as, for example, a speaker, microphone, display device, vibration device, keyboard, touch screen, just to name a few examples. In a particular implementation, user interface 535 may enable a user to interact with one or more applications hosted on mobile device 500. For example, devices of user interface 535 may store analog or digital signals on memory 540 to be further processed by DSP(s) 512 or general purpose processor 511 in response to action from a user. Similarly, applications hosted on mobile device 500 may store analog or digital signals on memory 540 to present an output signal to a user. In another implementation, mobile device 500 may optionally include a dedicated audio input/output (I/O) device 570 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 500 may comprise touch sensors 562 responsive to touching or pressure on a keyboard or touch screen device.

In one implementation, processing, conditioning, encoding or compression of signals representing captured images may be performed at general purpose processor 511 or DSP(s) 512. Alternatively, a dedicated video processor 568 may perform conditioning, encoding, compression or manipulation of signals representing captured images. Additionally, video processor 568 may decode/decompress stored image data for presentation on a display device 581 on mobile device 500.

In a particular implementation, mobile device 500 may comprise a dedicated modem processor 566 capable of performing baseband processing of signals received and downconverted at wireless transceiver 521 or SPS receiver 555. Similarly, modem processor 566 may perform baseband processing of signals to be upconverted for transmission by wireless transceiver 521. In alternative implementations, instead of having a dedicated modem processor, baseband processing may be performed by a general purpose processor or DSP (e.g., general purpose processor 511 or DSP(s) 512). It should be understood, however, that these are merely examples of structures that may perform baseband processing, and that claimed subject matter is not limited in this respect.

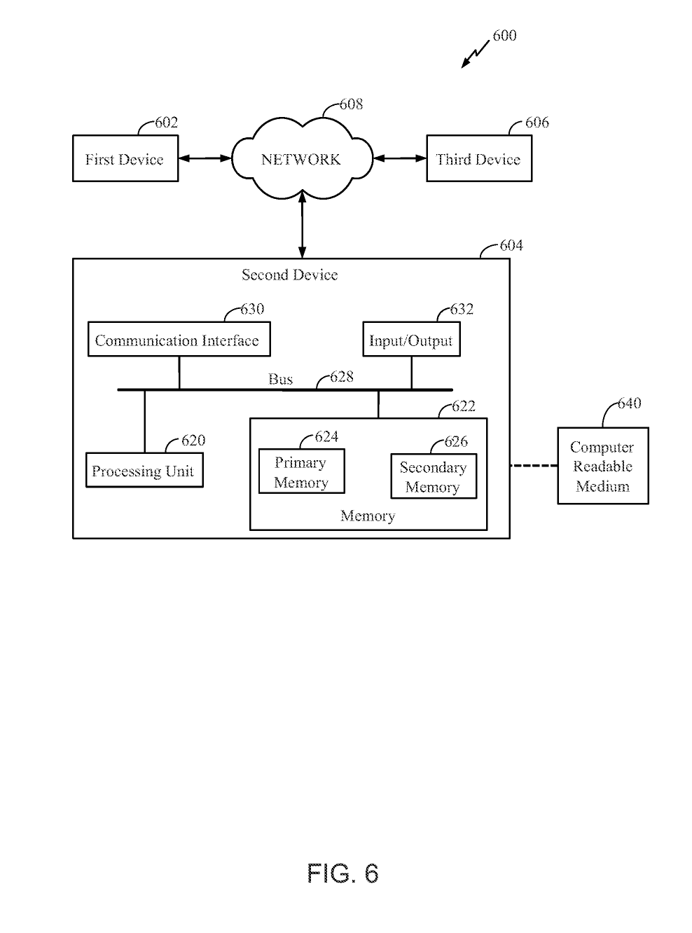

FIG. 6 is a schematic block diagram illustrating an example system 600 that may include one or more devices configurable to implement techniques or processes, such as processes 300 or 400 described above, for example. System 600 may include, for example, a first device 602, a second device 604, and a third device 606, which may be operatively coupled together through a wireless communications network 608.

First device 602, second device 604 and third device 606, as shown in FIG. 6, may be representative of any device, appliance or machine that may be configurable to exchange data over wireless communications network 608. By way of example but not limitation, any of first device 602, second device 604, or third device 606 may include; one or more computing devices or platforms, such as, e.g., a desktop computer, a laptop computer, a workstation, a server device, or the like; one or more personal computing or communication devices or appliances, such as, e.g., a personal digital assistant, mobile communication device, IP camera, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof.

Similarly, wireless communications network 608, as shown in FIG. 6, is representative of one or more communication links, processes, or resources configurable to support the exchange of data between at least two of first device 602, second device 604, and third device 606. By way of example but not limitation, wireless communications network 608 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 606, there may be additional like devices operatively coupled to wireless communications network 608.

It is recognized that all or part of the various devices and networks shown in system 600, and the processes and methods as further described herein, may be implemented using or otherwise including hardware, firmware, software, or any combination thereof.

Processing unit 620 is representative of one or more circuits configurable to perform at least a portion of a data computing procedure or process. By way of example but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620, such as via bus 628, for example.

Secondary memory 626 may include, for example, the same or similar type of memory as primary memory or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 640. Computer-readable medium 640 may include, for example, any non-transitory medium that can carry or make accessible data, code or instructions for one or more of the devices in system 600. Computer-readable medium 640 may also be referred to as a storage medium.

Second device 604 may include, for example, a communication interface 630 that provides for or otherwise supports the operative coupling of second device 604 to at least wireless communications network 608. By way of example but not limitation, communication interface 630 may include a network interface device or card, a modem, a router, a switch, a transceiver, and the like.

Second device 604 may include, for example, an input/output device 632. Input/output device 632 is representative of one or more devices or features that may be configurable to accept or otherwise introduce human or machine inputs, or one or more devices or features that may be configurable to deliver or otherwise provide for human or machine outputs. By way of example but not limitation, input/output device 632 may include an operatively configured display, speaker, keyboard, mouse, trackball, touch screen, data port, etc.

It will, of course, be understood that, although particular embodiments have just been described, claimed subject matter is not limited in scope to a particular embodiment or implementation. For example, one embodiment may be in hardware, such as implemented on a device or combination of devices, for example. Likewise, although claimed subject matter is not limited in scope in this respect, one embodiment may comprise one or more articles, such as a storage medium or storage media that may have stored thereon instructions capable of being executed by a specific or special purpose system or apparatus, for example, to result in performance of an embodiment of a method in accordance with claimed subject matter, such as one of the embodiments previously described, for example. However, claimed subject matter is, of course, not limited to one of the embodiments described necessarily. Furthermore, a specific or special purpose computing platform may include one or more processing units or processors, one or more input/output devices, such as a display, a keyboard or a mouse, or one or more memories, such as static random access memory, dynamic random access memory, flash memory, or a hard drive, although, again, claimed subject matter is not limited in scope to this example.

In the preceding description, various aspects of claimed subject matter have been described. For purposes of explanation, specific numbers, systems, or configurations may have been set forth to provide a thorough understanding of claimed subject matter. However, it should be apparent to one skilled in the art having the benefit of this disclosure that claimed subject matter may be practiced without those specific details. In other instances, features that would be understood by one of ordinary skill were omitted or simplified so as not to obscure claimed subject matter. While certain features have been illustrated or described herein, many modifications, substitutions, changes, or equivalents may now occur to those skilled in the art. It is, therefore, to be understood that the appended claims are intended to cover all such modifications or changes as fall within the true spirit of claimed subject matter.

What is claimed is:

1. A method performed at a cloud server, the method comprising:
establishing a first network connection to an Internet-Protocol (IP) camera in response to a request from said IP camera;
establishing a second network connection to a mobile device in response to a second request from said mobile device; and
facilitating a third network connection between said IP camera and said mobile device.

2. The method of claim 1, wherein said third network connection is routed through said cloud server.

3. The method of claim 1, wherein said third network connection comprises a peer to peer connection between said IP camera and said mobile device.

4. The method of claim 1, further comprising:
relaying photos/video between said IP camera and said mobile device using said third network connection.

5. The method of claim 1, further comprising:
relaying commands from said mobile device to said IP camera using said third network connection, said commands comprising instructions to capture an image or to record a video.

6. A method performed at a mobile device, the method comprising:
selecting a particular Internet protocol (IP) camera among one or more IP cameras;
transmitting a request over a first network connection to a cloud server to establish a second network connection to said particular IP camera;
receiving over said first network connection identification of said particular IP camera; and
receiving a photo/video stream over a third network connection from said particular IP camera.

7. The method of claim 6, wherein said third network connection includes said cloud server.

8. The method of claim 6, wherein said third network connection comprises a peer to peer connection between said particular IP camera and said mobile device.

9. The method of claim 6, wherein said second network connection comprises a peer to peer connection between said particular IP camera and said cloud server.

10. The method of claim 6, further comprising:
transmitting commands to said IP camera using said third network connection, said commands comprising instructions to capture an image or to record a video.

11. The method of claim 10, further comprising:
storing said image or said video in a memory.

12. The method of claim 6, further comprising:
transmitting said image or said video to a social media Internet e via said first network connection.

13. A non-transitory storage medium comprising machine-readable instructions stored thereon that are executable by a special purpose computing device to:
receive user instructions to select a particular Internet protocol (IP) camera among one or more IP cameras;
generate a request configured for communication over a first network connection to a cloud server to establish a second network connection to said particular IP camera;
receive identification of said particular IP camera via said first network connection; and
receive a photo/video stream via a third network connection from said particular IP camera.

14. The non-transitory storage medium of claim 13, wherein said third network connection includes said cloud server.

15. The non-transitory storage medium of claim 13, wherein said third network connection comprises a peer to peer connection between said particular IP camera and said mobile device.

16. The non-transitory storage medium of claim 13, wherein said second network connection comprises a peer to peer connection between said particular IP camera and said cloud server.

17. The non-transitory storage medium of claim 13, wherein said machine-readable instructions are further executable by said special purpose computing device to:
generate commands for transmission to said IP camera using said third network connection, said commands comprising instructions to capture an image or to record a video.

18. The non-transitory storage medium of claim 13, wherein said machine-readable instructions are further executable by said special purpose computing device to:
store said image or said video in a memory.

19. The non-transitory storage medium of claim 13, wherein said machine-readable instructions are further executable by said special purpose computing device to:
generate a signal comprising said image or said video for transmission to a social media Internet site via said first network connection.
